(19) United States
(12) Patent Application Publication
(10) Pub. No.: US 2007/0192281 A1
(43) Pub. Date: Aug. 16, 2007

(54) Methods and apparatus for displaying real-time search trends in graphical search specification and result interfaces

(75) Inventors: Ryan Kirk Cradick, Rochester, MN (US); Zachary Adam Garbow, Rochester, MN (US)

Correspondence Address: HARRINGTON & SMITH, PC, 4 RESEARCH DRIVE, SHELTON, CT, 06484-6212, US

(73) Assignee: International Business Machines Corporation

(21) Appl. No.: 11/346,768

(22) Filed: Feb. 2, 2006

(51) Int. Cl. G06F 17/30

(52) U.S. Cl. 707/2

(57) ABSTRACT

The present invention concerns methods and apparatus for displaying real-time search trends in graphical search specification and result interfaces. In the methods and apparatus of the present invention, a user enters a text-based search argument using a search specification and result interface associated with a search engine. Search results received in response to the search argument are listed in a search results display component of the search specification and result interface. The user then modifies the search argument using a graphical search argument representation component which visually depicts the search argument and associated search parameters (such as, for example, location; search term frequency, etc.). The graphical search argument representation component has controls for modifying the search argument using a visual paradigm. As the user modifies the search argument with the controls of the graphical search argument representation component, graphical search trend indicators indicate the effect on search results in real time. The effect of modifications to the search argument on search results as reflected in the graphical search trend indicators help a user to decide whether modifications to the search argument made with the graphical search argument representation component are improving, or worsening, the accuracy of the search.

### TECHNICAL FIELD

The present invention generally concerns graphical search specification and result interfaces for use with search engines, where search arguments are modified using a graphical search argument representation component, and more particularly concerns a search specification and results interface having a search results display component where search result trends are depicted using graphical search trend indicators.

### BACKGROUND

Current search engines typically have a search specification and result user interface. The search specification component of such an interface allows a user to specify a search argument for use in performing a search of, for example, the internet; a database; a computer hard drive; etc. The result component of such an interface displays resources located in response to the search.

The search specification component of most current search engines comprises a text box where users enter text search arguments to begin searches. In addition, many search engines also incorporate the ability to specify Boolean search arguments. In both instances, a user formulates a search criterion, formulates a search argument which encapsulates the search criterion, submits the search argument, and then receives the results of the search.

The process is sequential in nature. If a particular search argument fails to locate the desired information or resource, the user then begins a trial-and-error process to improve the search argument.

This process is hindered by the delay between when a user first formulates a new search criterion, submits a new search argument encapsulating the search criterion, and actually receives the search results. Due to the sequential nature of the process and the resulting unavoidable time delay involved, it is difficult for a user to develop an understanding of how modifications to the search criterion and resultant changes in the search argument actually impact search results. This process is further hindered if a user has a relatively limited understanding of the proper formulation of Boolean search arguments. The ability to formulate Boolean search arguments might even become a hindrance, since poorly-formulated search arguments might be counter-productive and drive a user even further away from desired results.

Advances nonetheless have been made in search engines. For example, it has been proposed that search arguments, after having been entered using a text input facility, be represented by and modified using an interactive graphical user interface. The graphical user interface depicts the search argument in a conceptual, visual form, and controls are provided for modifying the search argument using a visual paradigm. The effect of modification of the search argument is visually depicted in the graphical user interface associated with the search engine.

Such graphical user interfaces may be hampered by the same problems associated with search engines having text-only search specification and modification facilities. In particular, it may be difficult to understand how modifications to a search argument made using the visual controls actually impact search results. In addition, such graphical user interfaces provide no facility for suggesting how a search argument may be modified to improve search accuracy.

Accordingly, those skilled in the art desire search engines with graphical user interface facilities which dynamically indicate the effect of modifications made to search arguments on search results. Those skilled in the art also desire search engines with graphical user interface facilities which suggest how a search argument may be modified to improve search accuracy.

### SUMMARY OF THE PREFERRED EMBODIMENTS

The foregoing and other problems are overcome, and other advantages are realized, in accordance with the following embodiments of the present invention.

A first embodiment of the invention comprises a signal-bearing medium tangibly embodying a program of machine-readable instructions executable by a digital processing apparatus of a computer system to perform operations for controlling a graphical user interface, the operations comprising: receiving search results located using a first search argument; receiving a modification to the first search argument made with an interactive control associated with a graphical search argument representation component of an interactive search specification and result interface, the modification creating a second search argument; performing a search using the second search argument; receiving search results located using the second search argument; comparing the search results located using the second search argument with the search results located using the first search argument; and using a graphical search trend indicator to show an effect of the modification to the first search argument on search results located using the first search argument.

A second embodiment of the invention comprises a method to perform operations for controlling a graphical user interface, the operations comprising: displaying an interactive graphical user interface for performing searches, the interactive graphical user interface comprising: a search input component for entering a text-based search argument; a graphical search argument representation component for visually representing the text-based search argument and for visually modifying the text-based search argument, the graphical search argument representation component further comprising: a search argument display area for visually representing the text-based search argument; and at least one interactive control for modifying the text-based search argument using a visual metaphor; a search results display area; and a graphical search trend indicator for visually depicting an effect on search results of a change made to the text-based search argument using the at least one interactive control; receiving a text-based search argument entered using the search input component; performing a search using the text-based search argument; graphically depicting the text-based search argument in the search display area; depicting search results located in response to the search performed using the text-based search argument in the search results display area; receiving a modification of the text-based search argument, wherein the modification was made using the at least one interactive control; and using the graphical search trend indicator to visually depict an effect on the search results of the modification made to the text-based search argument using the at least one interactive control.

A third embodiment of the present invention comprises a computer system for displaying a graphical user interface for use in performing searches, the computer system comprising: at least one memory to store at least one program of machine-readable instructions, where the at least one program performs operations to display an interactive graphical user interface for performing searches when executed; a display for displaying the graphical user interface for performing searches; and at least one processor coupled to the at least one memory and display, wherein the at least one processor performs at least the following operations when the at least one program is executed: displaying an interactive graphical user interface for performing searches, the interactive graphical user interface comprising: a search input component for entering a text-based search argument; a graphical search argument representation component for visually representing the text-based search argument and for visually modifying the text-based search argument, the graphical search argument representation component further comprising: a search argument display area for visually representing the text-based search argument; and at least one interactive control for modifying the text-based search argument using a visual metaphor; a search results display area; and a graphical search trend indicator for visually depicting an effect on search results of a change made to the text-based search argument using the at least one interactive control; receiving a text-based search argument entered using the search input component; performing a search using the text-based search argument; graphically depicting the text-based search argument in the search display area; depicting search results located in response to the search performed using the text-based search argument in the search results display area; receiving a modification of the text-based search argument, wherein the modification was made using the at least one interactive control; and using the graphical search trend indicator to visually depict an effect on the search results of the modification made to the text-based search argument using the at least one interactive control.

In conclusion, the foregoing summary of the embodiments of the present invention is exemplary and non-limiting. For example, one skilled in the art will understand that one or more aspects or steps from one embodiment can be combined with one or more aspects or steps from another embodiment to create a new embodiment within the scope of the present invention.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 depicts a graphical user interface for performing searches in which the methods and apparatus of the present invention may be practiced;

FIG. 2 depicts a graphical user interface showing search trend indicators operating in accordance with the present invention;

FIG. 3 is a flowchart depicting a method operating in accordance with the present invention; and

FIG. 4 is a graphical user interface showing alternate search trend indicators operating in accordance with the present invention.

### DETAILED DESCRIPTION OF THE PREFERRED EMBODIMENTS

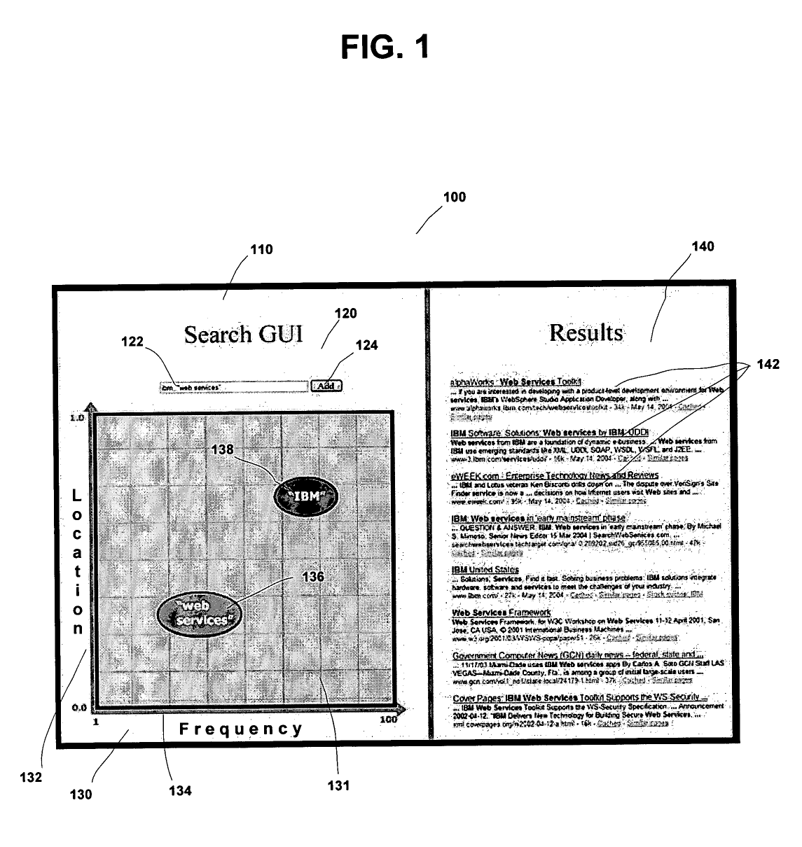

FIG. 1 depicts a graphical user interface 100 in which the methods of the present invention may be practiced. The graphical user interface 100 is intended to operate as a search specification and results interface as part of a search engine. The graphical user interface 100 has a search input component 120 for entering text-based search arguments. The search input component 120 comprises a text entry box 122 for entering text-based search arguments and a control button 124 for controlling addition of more search terms once a text-based search argument has been specified. The graphical user interface 100 further comprises a graphical search argument representation component 130 for visually representing the text-based search argument and for visually modifying the text-based search argument. As is apparent, words entered in the text entry box 122 which comprise the text-based search argument have been visually represented in a search argument display area 131 of the graphical search argument representation component 130. Graphical elements 136, 138 visually represent the individual search terms. The search argument display area 131 has axes 132, 134 for graphically representing search parameters associated with the text-based search argument. For example, axis 132 represents a first search parameter—“location”— associated with the search terms, and axis 134 represents a second search parameter—“frequency”—associated with the search terms. “Location” refers to the part of the resource in which the search term is located (e.g., words in a title or heading have a higher location factor than a term appearing in the body). Frequency refers to how many times the search term appears in a resource.

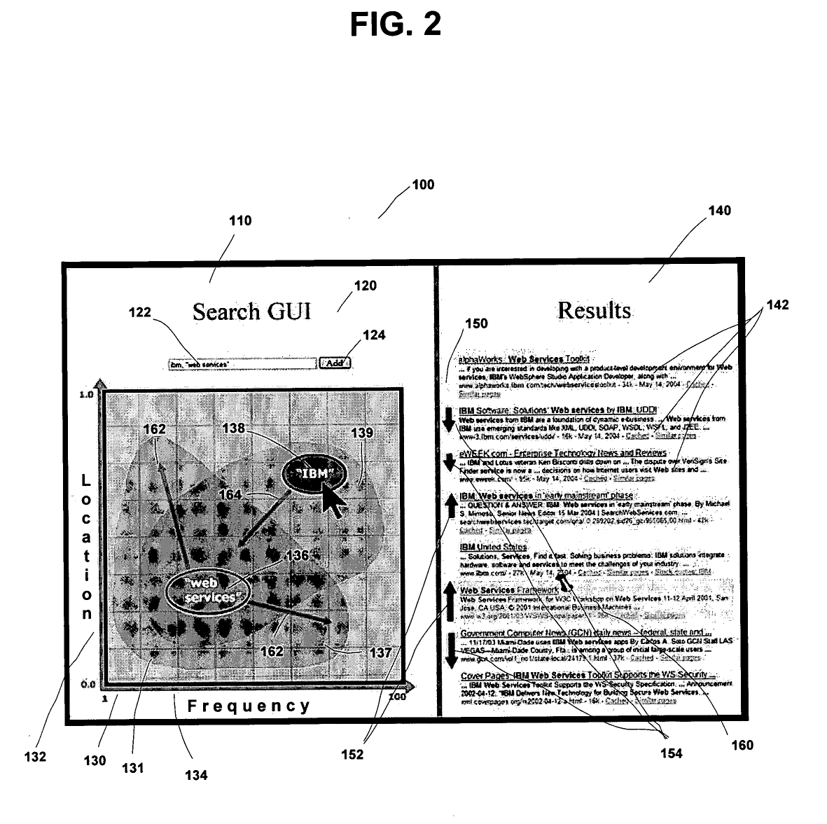

FIG. 2 depicts operation of the invention. Once a user performing a search has entered search terms comprising the text-based search argument, the user can modify the text-based search argument using interactive controls associated with the graphical search argument representation component 130. As is seen in FIG. 2, the user drags graphical elements 136, 138 corresponding to the search terms around the search argument display area 131. The movement of graphical elements 136, 138 changes one or both of the location factor and frequency factor associated with the search terms. In the prior art, whether associated with conventional text-only search controls, or associated with search controls having visual search argument modification facilities, a user had no way of observing the impact of modifications to search arguments on search results, other than by interpreting search results that are actually returned. For example, in a text search, a user enters the text search and receives results. If the user is dissatisfied with the results, the user modifies the search argument, or enters a new search argument, and receives new results. In this conventional mode of operation, a user is not provided with any feedback on how modifications to search arguments impact search results, other than by analyzing the actual search results.

In contrast, in methods and apparatus of the present invention, when a user modifies a text-based search argument using controls associated with the graphical search argument representation component 130, the impact the modification has on individual resources identified in a search results display area 140 is depicted using search trend indicators 150. For example, if a particular resource moves up the results list as a result of the modification, a graphical indicator 152 (such as, for example, an “up” arrow) shows this. Alternatively, if a particular resource moves down the results list as a result of the modification, a graphical indicator 154 (such as, for example, a “down” arrow) shows this. In this manner, the user can determine whether modifications to search arguments made using controls associated with the graphical search argument representation component 130 are improving the search or worsening the search. In the embodiment depicted in FIG. 2, the size of the arrows 152, 154 is proportional to how much a resource moves up or down the results list in response to the modification of the search argument. As the user becomes familiar with individual resources located by the search, the user will identify particular resources that are correlated with an effective search. The user will then make modifications to the search argument that move such resources up the results list, with the expectation that similar highly-responsive resources will be moved up the results list as well. The search trend indicators 152, 154 are particularly useful for accomplishing this outcome. At the end of a series of modifications to the text-based search argument carried on while observing the search trend indicators 152, 154 a user will have populated the results list with the most-responsive resources, where the resources listed at the top of the results list represent the most desirable results.

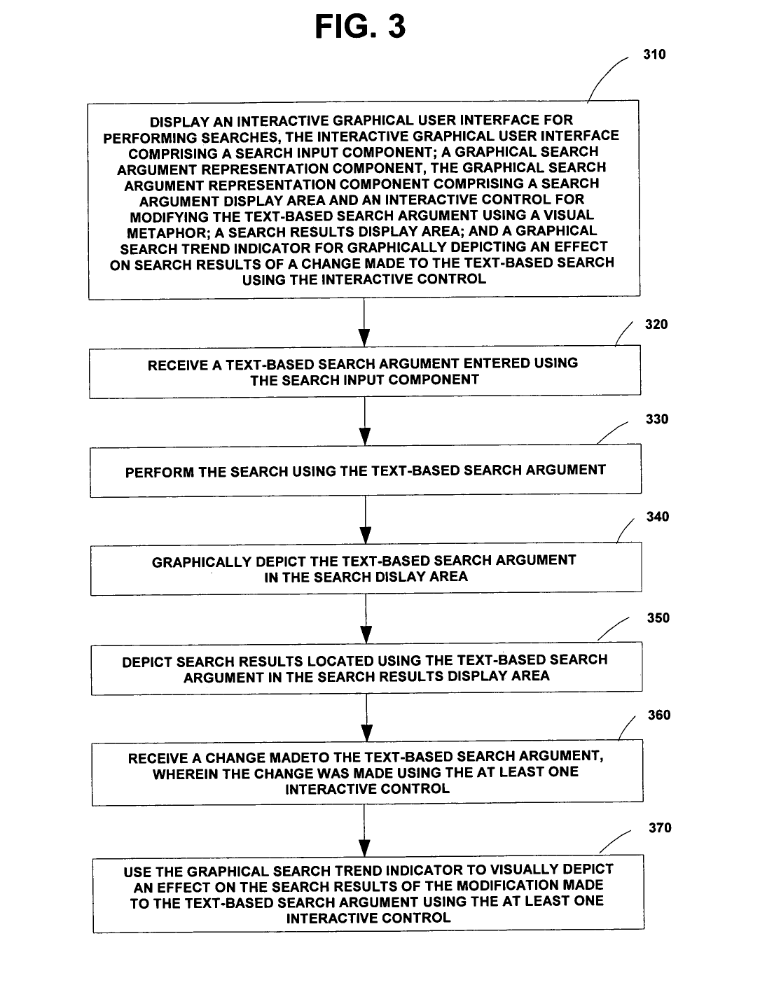

FIG. 3 is a flowchart depicting a method operating in accordance with the present invention, which will described with reference to FIGS. 1 and 2. The method begins at step 310, wherein an interactive graphical user interface 100 for performing searches is displayed on a display device of a computer system. The computer system (not shown) has a memory storing a computer program capable of performing operations in accordance with methods of the invention when executed; a display device for displaying graphical user interfaces operating in accordance with the invention; input devices for receiving control inputs from a user; and a processor coupled to the memory, display and input devices for executing the computer program. The interactive graphical user interface 100 comprises a search input component 120; a graphical search argument representation component 130; a search results display area 140; and graphical search trend indicators 150. The search input component 120 is for entering a text-based search argument. The graphical search argument representation component 130 is for visually representing the text-based search argument and for modifying the text-based search argument using a visual metaphor. The graphical search argument representation component 130 further comprises a search argument display area 131 for visually representing the text-based search argument; and at least one interactive control for modifying the text-based search argument using a visual metaphor. The search argument display area 131 graphically depicts the text-based search argument and associated search parameters. As shown in FIGS. 1 and 2, the search argument display area 131 comprises a two-axis graph. Graphical elements 136, 138 corresponding to individual text search terms comprising the text-based search argument are depicted in the search argument display area 131. Axes 132, 134 correspond to search parameters associated with each of the search terms comprising the text-based search argument. In the embodiment depicted in FIGS. 1 and 2 the search parameters correspond to “location” and “frequency”. As is apparent from FIGS. 1 and 2, each of the text search terms has an associated value for “location” and “frequency” that can be determined by reference to axes 132 and 134. The search parameters associated with the text search terms are modified by dragging the graphical elements 136, 138 corresponding to the text search terms about the search argument display area 131. This facility comprises an interactive control for modifying the text-based search argument using a visual metaphor. The search results display area 140 displays resources located in response to the search. In the embodiment depicted in FIGS. 1 and 2, the results comprise web pages located using the text-based search argument. The methods and apparatus of the present invention can be used in combination with any computer-based search engine to locate other resources such as, for example, databases; folders; files; computer components; etc. The graphical search trend indicators 150 are particularly advantageous aspects of the present invention and will be described in greater detail in the following description.

At step 320, the computer system receives a text-based search argument entered using the search input component 120. Then, at step 330, the computer system causes the search to be performed using the text-based search argument. Next, at step 340, the text-based search argument is graphically depicted in the search argument display area 131 and the search results are displayed in the search results display area 140. In embodiments of the invention, the resources returned as a result of the search are listed in order of responsiveness. One method of ranking the resources in order of responsiveness ranks the resources according to how many times the search terms comprising the text-based search argument appear in a particular resource. Other methods of ranking the resources are possible within the context of the present invention.

A particular advantage of the present invention will now be described. In conventional search specification and results interfaces, there are no facilities for displaying trends associated with a search. As described previously, in conventional search specification and result interfaces, a user enters a search argument, and then receives the results. A user can modify a search, but there are no facilities or functions illustrating how an initial search relates to a later modified search. The present invention overcomes this limitation of the prior art by providing graphical search trend indicators. The graphical search trend indicators 150 are depicted in FIG. 2 and operate to indicate trends caused by modification of a text-based search argument. Modification of the text-based search argument causes changes to the results located in response to the text-based search argument. Typically, modifications to the search argument cause resources located in response to the search argument to move up or down the results list. The search trend indicators provide a visual cue as to how much a particular resource will move, is moving, or has moved, up or down the results list in response to the search argument modification.

The steps of the method that implement this aspect of the invention begin at 360. There a modification of the text-based search argument is received, where the modification is made using an interactive control associated with the search argument display component 130. One such interactive control has been described previously, namely the ability to change search parameter values associated with particular search terms by dragging graphical elements 136, 138 corresponding to text search terms about the search argument display area 131. Next, at step 370, the effect on the search results of a change made to the text-based search argument is visually depicted using graphical search trend indicators 150 to indicate the trend.

The graphical search trend indicators 150 can be manipulated in various ways to show the search trend. In one possible embodiment, the search results are reshuffled in response to the modification of the search argument and then re-displayed. At the same time, the graphical search trend indicators are updated and displayed to indicate how a particular resource was impacted by the modification of the text-based search argument. As is apparent from FIG. 2, there are two types of graphical search trend indicators used in the embodiment depicted in FIG. 2. An “up” arrow 152 indicates that a particular resource moved “up” the results list in response to the modification to the text-based search argument. A “down” arrow 154 indicates that a particular resource moved “down” the results list in response to the modification the text-based search argument. The size of the arrows 152, 154 are proportional to the amount of movement.

In another embodiment, before the resources comprising the results list are reshuffled in response to the modification to the text-based search argument, the graphical search trend indicators are updated and momentarily displayed to show how particular resources will move in response to the text-based search argument modification. It is conceivable that a poorly conceived modification may cause a resource that is well-correlated with an accurate search to move down the list so far as to be no longer visible. This particular embodiment of the invention captures these situations. In other embodiments, these immediately preceding two embodiments may be combined. In such an embodiment, the graphical search trend indicators would be updated prior to reshuffling the resources comprising the results list to show how particular resources that are currently visible will move in response to search argument modifications, and once the results are reshuffled, the graphical search trend indicators will continue to be displayed to indicate how much a resource moved in response to the last modification of the text-based search argument.

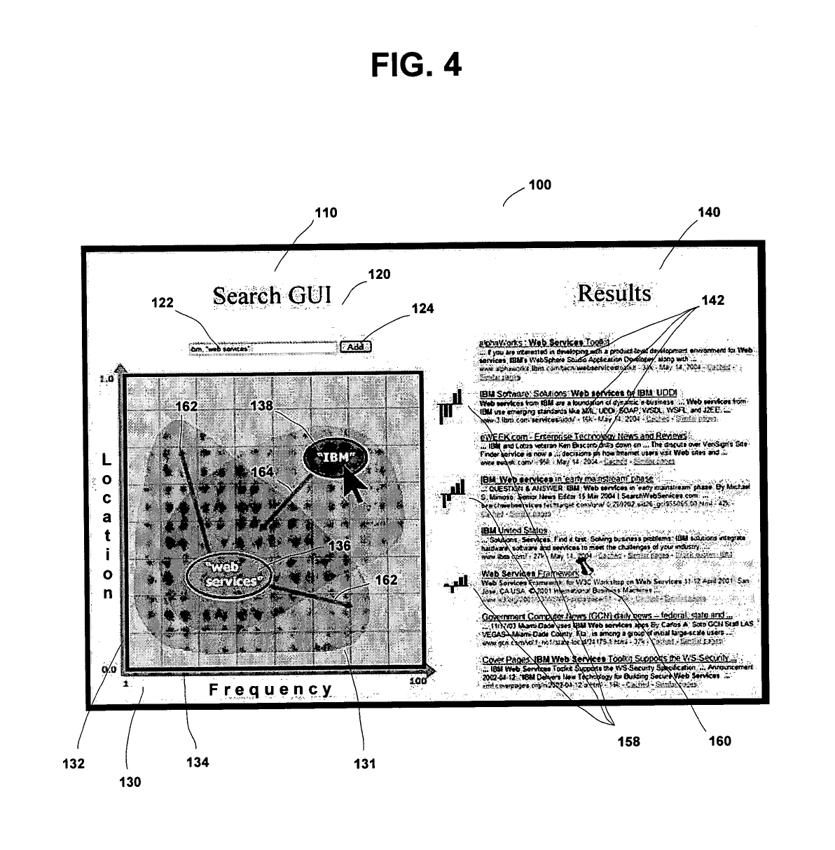

Other graphical search trend indicators can be implemented in accordance with the present invention. For example, one such trend indicator 158 has the appearance of a graphical equalizer as shown in FIG. 4, and operates as follows. After each modification of the text-based search argument, the rightmost bar is updated to show the impact of the most recent modification on the resource displayed adjacent to the graphical search trend indicator. If the particular resource moved down the list, a negative bar is depicted. If the particular resource moved up the list, a positive bar is depicted. When another modification to the text-based search argument is made, the bar associated with the immediately preceding modification moves leftward for each of the graphical search trend indicators 158 and a new bar is displayed corresponding to the most recent modification of the text-based search argument. After a number of such modifications, the graphical search trend indicator displays not only the trend associated with the most recent modification to the text-based search argument, but also a trend history indicating how prior modifications to the text-based search argument impacted a particular resource in the results list. The details associated with this embodiment of the present invention are exemplary; this embodiment can be implemented in other ways in accordance with the present invention. In essence, the graphical search trend indicators 158 operate as graphical search trend and history indicators since they reflect the history of effects on a particular resource of modifications made to the search argument.

As described so far, search trend indicators operating in accordance with the present invention show present change as a result of an already-made modification to a search argument, where the present change may be depicted either in isolation or in combination with graphical elements which indicate trends associated with past modifications to a search argument (as in the case of the graphical search trend and history indicator).

Search trend indicators operating in accordance with the present invention can also show predicted future changes in search results by analyzing, for example, a trajectory associated with current modifications to a search argument. Methods operating in accordance with the present invention would predict a future trajectory of a modification to a search argument in real time by extrapolating from the initial stages of the modification as it is made, and would predict search trends associated with one or more points along the future trajectory. This may be accomplished either by analyzing preceding search results, or by actually performing searches for points along the predicted future trajectory.

The future search trends would then be depicted with the graphical search trend indicators described and depicted herein. For example, a method operating in accordance with the present invention would predict the future positions of the graphical element 138 from initial movements of the graphical element by a user. As depicted in FIG. 4, element 164 may correspond to a direction that a user is moving element 138. From an initial movement, the method would predict future positions. When the method is used in combination with the search trend indicator depicted in FIG. 4, the bars of the graphical search trend indicator could be color-coded with three colors to indicate whether the bar corresponds to a search trend associated with a past modification to a search argument; a present modification to a search argument; or a predicted future modification to a search argument.

Still further graphical search trend indicators can be implemented in accordance with the present invention. For example, typical events that occur when a search argument is modified are that some resources disappear from the results list, and other resources appear for the first time in the results list. A graphical search trend indicator that may be used to depict that a resource will disappear, or has disappeared, from the search results list may comprise transitioning the resource to a smaller font in the resource list, or to a flashing font, or to the combination of both. A graphical search trend indicator that may be used to depict that a resource has appeared for the first time in response to modification of the text-based search argument is displaying the resource in bold-face in the results list, or in a flashing font, or using the combination of both.

Another aspect of the invention is that it provides cues to a user to indicate how a search may be modified to maximize the position of a particular resource in the results list. For example, a user may conclude that a particular resource located in response to a text-based search argument is highly responsive to the user's desire, and that the user desires that the text-based search argument be modified in such a way that the particular resource will be moved to the top of the results list. It is assumed that other highly desirable resources will likewise move upward as a result of the contemplated modification.

The operation of this aspect of the present invention is depicted in FIG. 2. The user identifies a particular resource 160 as being highly desirable, and selects it as indicated by the graphical representation of a thumbtack 162. The computer system then performs operations to determine how the text-based search argument can be modified so that the thumbtacked resource 160 rises to the top of the search results list. Tracks that represent the desired modification 162, 164 are then displayed in the search argument display area.

A further aspect of the present invention is that methods and apparatus operate to determine combinations of search parameter values associated with a particular text search term or text search terms that either maintain, or eliminate a particular resource from a search results list. These combinations are then graphically depicted as regions 137, 139. In such an embodiment, the user selects a particular resource 160 in the results list and thumbtacks it. The computer system then performs operations to determine values for search parameters associated with the search terms that will just maintain the particular resource in the results list. Outside of the determined values, the particular resource will disappear from the results list. The resulting regions 137, 139 are shown in FIG. 2. As long as graphical element 136 is maintained in region 137, resource 160 will remain in the results list. Likewise as long as graphical element 138 is maintained in region 139, resource 160 will remain in the results list.

One of ordinary skill in the art will understand that the methods depicted and described herein can be embodied in a tangible machine-readable memory medium. A computer program fixed in a machine-readable memory medium and embodying a method or methods of the present invention perform steps of the method or methods when executed by a digital processing apparatus coupled to the machine-readable memory medium. Tangible machine-readable memory media include, but are not limited to, hard drives, CD- or DVD-ROM, flash memory storage devices or in a RAM memory of a computer system. A machine-readable memory medium tangibly embodying such a computer program comprises an embodiment of the present invention.

Thus it is seen that the foregoing description has provided by way of exemplary and non-limiting examples a full and informative description of the best methods and apparatus presently contemplated by the inventors for displaying real-time search trends resulting from modifications made to search arguments, wherein the modifications are made to search arguments using a graphical search argument representation component. One skilled in the art will appreciate that the various embodiments described herein can be practiced individually; in combination with one or more other embodiments described herein; or in combination with graphical user interfaces differing from those described herein. Further, one skilled in the art will appreciate that the present invention can be practiced by other than the described embodiments; that these described embodiments are presented for the purposes of illustration and not of limitation; and that the present invention is therefore limited only by the claims which follow.

We claim:

1. A signal-bearing medium tangibly embodying a program of machine-readable instructions executable by a digital processing apparatus of a computer system to perform operations for controlling a graphical user interface, the operations comprising:
receiving search results located using a first search argument;
receiving a modification to the first search argument made with an interactive control associated with a graphical search argument representation component of an interactive search specification and result interface, the modification creating a second search argument;
performing a search using the second search argument;
receiving search results located using the second search argument;
comparing the search results located using the second search argument with the search results located using the first search argument; and
using a graphical search trend indicator to show an effect of the modification to the first search argument on search results located using the first search argument.

2. The signal-bearing medium of claim 1 wherein search results located using a particular search argument comprise a listing of resources, the listing of resources displayed in a search results display area of the interactive search specification and result interface, the resources listed in order of responsiveness to the particular search argument, the operations further comprising:
receiving a selection of a particular resource appearing in a listing of resources located using the second search argument;
determining at least one additional modification which, if made to the second search argument, will move the selected particular resource up the listing of resources; and
graphically depicting how to make the additional modification to the second search argument in a search argument display area associated with the graphical search argument representation component of the interactive search specification and result interface.

3. The signal-bearing medium of claim 1 wherein search results located using a particular search argument comprise a listing of resources, the operations further comprising:
receiving a selection of a particular resource appearing in a listing of resources located using the second search argument;
determining a range of permissible additional modifications to the second search argument which, if made to the second search argument, will maintain the selected particular resource in the listing of resources located using the second search argument, wherein modifications outside the range of permissible additional modifications will, if made to the second search argument, cause the selected particular resource to drop off the listing of resources; and
graphically depicting the range of permissible additional modifications in a search argument display area associated with the graphical search argument representation component of the interactive search specification and result interface.

4. The signal-bearing medium of claim 1 wherein search results located using the first search argument comprise a listing of resources, the listing of resources displayed in a search results display area of the interactive search specification and result interface, the resources listed in order of responsiveness to the particular search argument, whereby using the graphical search trend indicator further comprises:
using the graphical search trend indicator to indicate that at least one resource will move up the results list in response to the modification to the first search argument.

5. The signal-bearing medium of claim 4 wherein a dimension of the graphical search trend indicator is proportional to a distance that the at least one resource will move up within the listing of resources as a result of the modification to the first search argument.

6. The signal-bearing medium of claim 4 wherein the graphical search trend indicator comprises an upward-pointing arrow.

7. The signal-bearing medium of claim 1 wherein search results located using the first search argument comprise a listing of resources, the listing of resources displayed in a search results display area of the interactive search specification and result interface, the resources listed in order of responsiveness to the particular search argument, whereby using the graphical search trend indicator further comprises:
using the graphical search trend indicator to indicate that at least one resource will move down the results list in response to the modification to the first search argument.

8. The signal-bearing medium of claim 7 wherein a dimension of the graphical search trend indicator is proportional to a distance that the at least one resource will move down within the listing of resources as a result of the modification to the first search argument.

9. The signal-bearing medium of claim 7 wherein the graphical search trend indicator comprises a downward-pointing arrow.

10. The signal-bearing medium of claim 1 wherein search results located using the first search argument comprise a listing of resources, the listing of resources displayed in a search results display area of the interactive search specification and result interface, the resources listed in order of responsiveness to the particular search argument, whereby using a graphical search trend indicator further comprises:
using the graphical search trend indicator to indicate that at least one resource will appear in the results list for the first time in response to the modification to the first search argument.

11. The signal-bearing medium of claim 1 wherein search results located using the first search argument comprise a listing of resources, the listing of resources displayed in a search results display area of the interactive search specification and result interface, the resources listed in order of responsiveness to the particular search argument, whereby using the graphical search trend indicator further comprises:
using the graphical search trend indicator to indicate that at least one resource will disappear from the results list in response to the modification to the first search argument.

12. The signal-bearing medium of claim 1 wherein search results located using a particular search argument comprise a listing of resources, the listing of resources displayed in a search results display area of the interactive search specification and results interface, the resources listed in order of responsiveness to the particular search argument, the operations further comprise:
receiving a series of search argument modifications made with the interactive control associated with the graphical search argument representation component of the interactive search specification and result interface, each successive modification creating a newly-modified search argument from an immediately preceding search argument;
performing a search with each newly-modified search argument;
receiving search results located using each newly-modified search argument;
comparing the search results located with each newly-modified search argument with search results located using the immediately-preceding search argument; and
for a particular resource which appeared in search results located using each newly-modified search argument, using a graphical search trend and history indicator to indicate how the particular resource was impacted by each search argument modification, whereby the graphical search trend and history indicator reflects a history of impacts of the search argument modifications on the particular resource.

13. The signal-bearing medium of claim 12 wherein the graphical search trend and history indicator comprises a bar graph, wherein a positive bar corresponds to a search argument modification that caused the particular resource to move up the results list and a negative bar corresponds to a search argument modification that caused the particular resource to move down the results list.

14. The signal bearing medium of claim 1 wherein the operations further comprise:
predicting a future modification to the second search argument by extrapolating from the modification made to the first search argument to create the second search argument;
determining search results associated with the predicted future modification; and
using the graphical search trend indicator to depict a search trend associated with the predicted future modification of the search argument.

15. A method to perform operations for controlling a graphical user interface, the operations comprising:
displaying an interactive graphical user interface for performing searches, the interactive graphical user interface comprising:
a search input component for entering a text-based search argument;
a graphical search argument representation component for visually representing the text-based search argument and for visually modifying the text-based search argument, the graphical search argument representation component further comprising:
a search argument display area for visually representing the text-based search argument; and
at least one interactive control for modifying the text-based search argument using a visual metaphor;
a search results display area; and
a graphical search trend indicator for visually depicting an effect on search results of a change made to the text-based search argument using the at least one interactive control;
receiving a text-based search argument entered using the search input component;
performing a search using the text-based search argument;
graphically depicting the text-based search argument in the search display area;
depicting search results located in response to the search performed using the text-based search argument in the search results display area;
receiving a modification of the text-based search argument, wherein the modification was made using the at least one interactive control; and
using the graphical search trend indicator to visually depict an effect on the search results of the modification made to the text-based search argument using the at least one interactive control.

16. The method of claim 15 wherein graphically depicting the text-based search argument in the search display area further comprises displaying graphical elements corresponding to text search terms comprising the text-based search argument in the search display area.

17. The method of claim 16 wherein at least one search parameter is associated with each search term comprising the text-based search argument; wherein the at least one interactive control allows a user to alter the at least one search parameter associated with each of the search terms comprising the text-based search argument; wherein receiving a modification of the text-based search argument further comprises receiving a change to the at least one search parameter associated with at least one of the search terms comprising the text-based search argument, whereby the change is made visually using the at least one interactive control.

18. The method of claim 15 wherein search results located using the text-based search argument comprise a listing of resources, the listing of resources displayed in the search results display area, the resources listed in order of responsiveness to the text-based search argument, the operations further comprising:
receiving a selection of a particular resource appearing in the listing of resources located using the text-based search argument;
determining at least one additional modification which, if made to the text-based search argument, will move the selected particular resource up the listing of resources; and
graphically depicting how to make the at least one additional modification to the text-based search argument in the search argument display area of the graphical search argument representation component.

19. The method of claim 15 wherein the search results located using the text-based search argument comprise a listing of resources, the operations further comprising:
receiving a selection of a particular resource appearing in the listing of resources located using the text-based search argument;
determining a range of permissible modifications to the text-based search argument which, if made to the text-based search argument, will maintain the selected particular resource in the listing of resources located using the text-based search argument, wherein modifications outside the range of permissible additional modifications will, if made to the text-based search argument, cause the selected particular resource to drop off the listing of resources; and
graphically depicting the range of permissible additional modifications in the search argument display area of the graphical search argument representation component of the interactive search specification and result interface.

20. A computer system for displaying a graphical user interface for use in performing searches, the computer system comprising:
at least one memory to store at least one program of machine-readable instructions, where the at least one program performs operations to display an interactive graphical user interface for performing searches when executed;
a display for displaying the graphical user interface for performing searches; and
at least one processor coupled to the at least one memory and display, wherein the at least one processor performs at least the following operations when the at least one program is executed:
displaying an interactive graphical user interface for performing searches, the interactive graphical user interface comprising:
a search input component for entering a text-based search argument;
a graphical search argument representation component for visually representing the text-based search argument and for visually modifying the text-based search argument, the graphical search argument representation component further comprising:
a search argument display area for visually representing the text-based search argument; and
at least one interactive control for modifying the text-based search argument using a visual metaphor;
a search results display area; and
a graphical search trend indicator for visually depicting an effect on search results of a change made to the text-based search argument using the at least one interactive control;
receiving a text-based search argument entered using the search input component;
performing a search using the text-based search argument;
graphically depicting the text-based search argument in the search display area;
depicting search results located in response to the search performed using the text-based search argument in the search results display area;
receiving a modification of the text-based search argument, wherein the modification was made using the at least one interactive control; and
using the graphical search trend indicator to visually depict an effect on the search results of the modification made to the text-based search argument using the at least one interactive control.
